(19) United States
(12) Patent Application Publication
(10) Pub. No.: US 2008/0250938 A1
(43) Pub. Date: Oct. 16, 2008

(54) FRYER

(75) Inventor: Hideki Kijimoto, Nagoya-Shi (JP)

Correspondence Address: BURR & BROWN, PO BOX 7068, SYRACUSE, NY, 13261-7068, US

(73) Assignee: Paloma Industries, Limited, Nagoya-Shi (JP)

(21) Appl. No.: 12/027,299

(22) Filed: Feb. 7, 2008

(30) Foreign Application Priority Data
Apr. 10, 2007 (JP) 2007-103048

(51) Int. Cl. A47J 37/12

(52) U.S. Cl. 99/403

(57) ABSTRACT

A fryer in which solid oil for supplement and replacement is stocked with a reduced space and the solid oil is liquefied with a low cost is provided. In this fryer, a housing portion 23 for an oil can 25 having solid oil for supplement and replacement is provided at the bottom of a main body case 2 and a part of exhaust gas from a pulse burner 4 is guided into the housing portion 23, so that the oil can 25 is heated by exhaust heat of the exhaust gas. In addition, an oil supply hose 30 is connected between the oil can 25 and an inlet portion of a pump 20 to provide oil in the oil can 25 into an oil vat 3 with the pump 20.

### BACKGROUND OF THE INVENTION

This application claims the benefit of Japanese Patent Application Number 2007-103048 filed on Apr. 10, 2007, the entirety of which is incorporated by reference.

1. Field of the Invention

The present invention relates to a fryer in which solid oil is heated to be liquefied and liquid oil is heated in an oil vat, and foods are put into the oil vat to be cooked.

2. Description of the Related Art

As shown in Japanese Patent Unexamined Publication No. 2000-166774, a fryer has a main body case which includes an oil vat to be filled with cooking oil, a pulse burner for heating oil in the oil vat, and an oil circulation route (an oil cleaner) having an oil tank and an pump for filtering oil discharged from the oil vat and returning the oil into the oil vat. Oil used in the oil vat is produced by heating solid oil such as lard to melt, and in this publication document an oil supply apparatus is provided at the upper side of the oil vat. The oil supply apparatus includes a supply tank for storing solid oil for supplement, a sheath heater which heats the supply tank to liquefy the solid oil, and a supply route for supplying liquid oil from the supply tank to the oil vat.

In the above fryer, the oil supply apparatus is separately provided from the main body case. Because of this, an installation space of the fryer including the oil supply apparatus becomes large, so that there would be a case that the oil supply apparatus cannot be installed depending on an installation place of the fryer. Moreover, in addition to the separate apparatus, a heating means for heating solid oil needs to be separately provided, which invites an increased cost. Moreover, the solid oil is supplied into the supply tank provided at the upper side of the oil vat, which becomes a burden for an operator.

In view of the above, an object of the present invention is to provide a fryer in which solid oil for supplement and replacement is stocked with a reduced space and the solid oil is liquefied with a low cost.

### SUMMARY OF THE INVENTION

In order to achieve the above object, in a first aspect of the present invention, a housing portion for an oil can having solid oil for supplement and replacement is provided at the bottom of a main body case and a part of exhaust gas from a heating means for oil is guided into the housing portion, so that the oil can is heated by exhaust heat of the exhaust gas. In addition, a hose is connected between the oil can and an inlet portion of a pump to provide oil in the oil can into the oil vat with a pump.

In a second aspect of the present invention, in addition to an object of the first aspect, the housing portion includes a heater for heating at least a bottom surface of the oil can in order to liquefy the solid oil more efficiently.

In a third aspect of the present invention, in addition to an object of the first or second aspect, a slide table is provided at the bottom of the housing portion. On the slide table, the oil can is mounted so as to be easily slid into and slid out of the housing portion.

In a fourth aspect of the present invention, in addition to an object of any one of the first to third aspects, a fryer further comprises a temperature detecting means for detecting a temperature of the oil can and a notification means for notifying that the oil can is detected to reach a predetermined temperature by the temperature detecting means in order to improve usability concerning oil supplement.

According to the first aspect, solid oil for supplement and replacement is stocked in the main body case with a reduced space. Moreover, since the solid oil is heated using exhaust heat, the cost for solid oil liquefaction is reduced. Moreover, oil in the oil can is provided into the oil vat using the pump of the oil circulation route, so that supplement and replacement of oil is performed safely and simply.

According to the second aspect, in addition to an effect of the first aspect, by using the heater, solid oil is liquefied more efficiently and rapidly.

According to the third aspect, in addition to an effect of the first or second aspect, even a heavy oil can is easily slid into and out of the housing portion by means of the slide table.

According to the fourth aspect, in addition to an effect of any one of the first to third aspects, by means of the notification means, it is immediately recognized that solid oil in the oil can is liquefied and capable of being supplied, so that usability is improved.

### BRIEF DESCRIPTION OF THE DRAWINGS

FIG. 1A is a front view of a fryer, and FIG. 1B is an explanation view of the right side of the fryer.

FIG. 2 is an explanation view showing details of a housing portion.

### DESCRIPTION OF THE PREFERRED EMBODIMENT

Hereinafter, an embodiment of the present invention will be explained with reference to drawings.

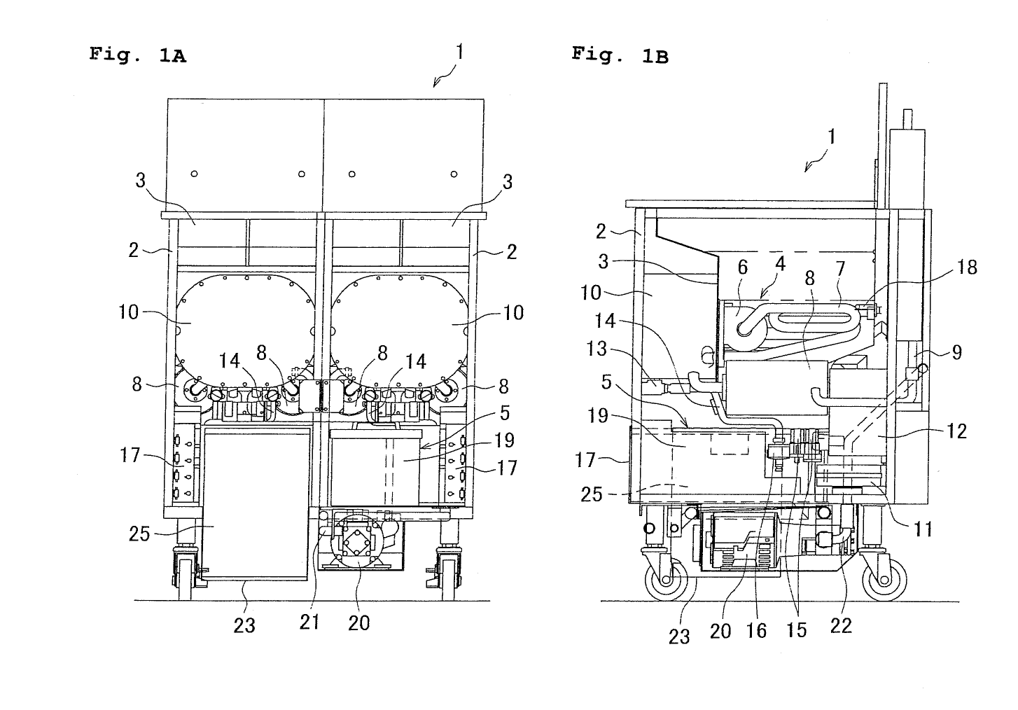

FIGS. 1A and 1B are explanation views showing an example of a fryer. FIG. 1A is a front view, and FIG. 1B is a right side view. A fryer 1 includes a pair of right and left main body cases 2, 2, each of which has an oil vat 3 to be filled with oil, a pulse burner 4 as a heating means for heating oil in the oil vat 3, and an oil cleaner 5 as an oil circulation route for filtering oil. Each pulse burner 4 has an exhaust gas system which includes a combustion chamber 6 provided in the oil vat 3 for performing pulse combustion, a tail pipe 7 through which exhaust gas from the combustion chamber 6 flows, decouplers 8, 8 connected at the downstream of the tail pipe 7 and provided on both sides of the oil vat 3, and an exhaust pipe 9 connected at the downstream of each decoupler 8 and provided at the rear of the main body case 2.

The reference number 10 denotes an air chamber provided at an outer front side of each oil vat 3. The air chamber has therein a not shown mixing chamber in communication with the combustion chamber 6. Combustion air is supplied from a fan 11 provided at the bottom of the main body case 2 through a muffler 12 and an inlet pipe 13. Moreover, a gas conduit 14 connected to the mixing chamber of the air chamber 10 is provided with solenoid valves 15, 15 for opening/closing a fuel gas supply route to the pulse burner 4, and a gas governor 16 for controlling gas pressure.

In each main body case 2, a controller 17 is provided at a lower front portion. The controller 17 is connected to the solenoid valves 15, 15 and a temperature sensor 18 provided in the oil vat 3. The controller 17 performs ON/OFF control in which mixed air combustion in the combustion chamber 6 is intermittently executed by opening/closing the solenoid valves 15, 15 so that oil temperature of the oil vat 3 is maintained with a predetermined range (for example, 180° C.-182° C.) based on a temperature detection signal from the temperature sensor 18.

On the other hand, the oil cleaner 5 has an oil tank 19 having an oil filter at the bottom. This oil tank 19 is connected to a not shown exhaust oil pipe extending from bottom portions of the right and left oil vats 3, 3. At the same time, the oil tank 19 has a piping 21 which guides filtered oil through the oil filter to an inlet portion of the pump 20. At the outlet portion of the pump 20, an oil supply pipe 22 communicating with each oil vat 3 is connected. Thus, when a valve provided with the exhaust oil pipe is opened so that oil flows into the oil tank 19 and the pump is driven by operation of the controller 17, oil filtered by the oil filter returns to the oil vat 3 through the oil supply pipe 22.

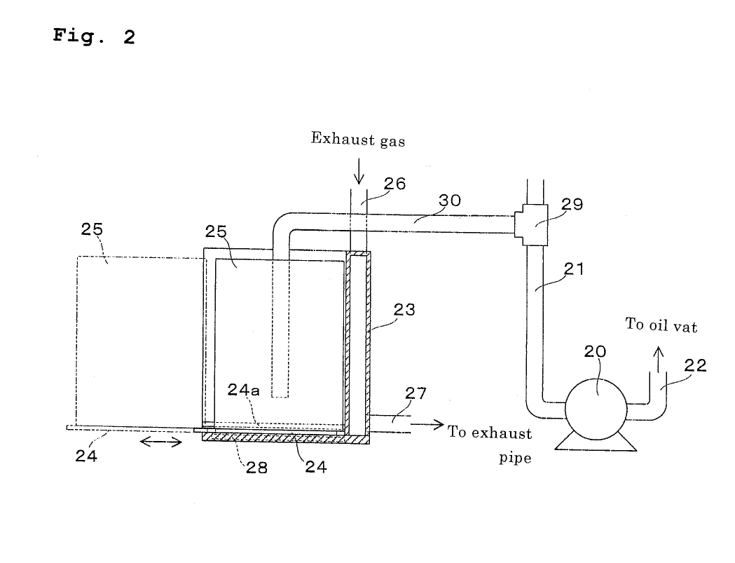

A housing portion 23 is provided at a bottom portion of the left main body case 2. As shown in FIG. 2, the housing portion 23 is a box-shaped body in which the front side and upper surface are open and a slide table 24 mounted at the bottom is slid to the front by means of a rail 24a attached on the inner lateral sides. An oil can 25 housing solid oil for supplement and replacement is disposed on the slide table 24, so that the oil can is easily slid in and out. In addition, each of three lateral walls of the housing portion 23 has a double structure including a hollow portion. An exhaust inlet pipe 26 connected to one decoupler 8 is inserted from the upper side of the housing portion, and an exhaust outlet pipe 27 connected to the exhaust pipe 9 is attached at the rear bottom of the housing portion. Because of this structure, a part of exhaust gas discharged from the tail pipe 7 passes through the inside of the housing portion 23. In addition, at the bottom of the hosing portion 23, a heater 28 electrically controlled by the controller 17 is embedded. Furthermore, a three-way valve 29 is provided with the piping 21 between the oil tank 19 and the pump 20, and an oil supply hose 30 connects the three-way valve 29 and the upper surface of the oil can 25.

In the fryer 1 configured as above, the oil vat 3 is filled with oil and the oil can 25 is previously placed in the housing portion 23. In this state, the pulse burner 4 performs ON/OFF control by means of the controller 17, and thus the oil is heated to be at a predetermined temperature. Thereafter, foods are put with a basket, and then foods are cooked with high-temperature oil. During the cooking, exhaust gas generated by combustion of mixed air in the combustion chamber 6 moves from the tail pipe 7 into the decoupler 8, and is discharged from the exhaust pipe 9 to the rear of the main body case 2. Here, in the left main body case 2, a part of exhaust gas branched from one decoupler 8 is supplied into the housing portion 23 through the exhaust inlet pipe 26. Then, the housing portion 23 is heated by this exhaust gas and accordingly, the oil can 25 housed therein is heated. Further, at the same time, the heater 28 is electrically operated, so that the oil can 25 is heated from the bottom, too.

Since the oil can 25 is heated, solid oil in the oil can 25 is melted and liquefied. In addition, a temperature sensor (temperature detecting means) such as a bimetal switch is provided in the housing portion 23. Thus, when the oil can 25 reaches a predetermined temperature (that is, 50° C.-70° C. for liquefying solid oil), the controller 17 executes notification using notification means, for example, alarming with a buzzer or flashing a lamp.

In the oil vat 3, the amount of oil is reduced due to oil absorption by foods and oil evaporation by heating. Then, the oil supply hose 30 connected to the piping 21 is inserted from the upper surface of the oil can 25 in the housing portion 23 and the three-way valve 29 is switched to connect the oil supply hose 30 with the piping 21, and then the pump 20 is driven by the controller 17. By doing this, oil liquefied in the oil can 25 is suctioned from the oil supply hose 30 and poured into the oil vat 3 through the oil supply pipe 22, so that oil is supplemented. The amount of oil to be supplied can be previously set in the controller 17, for example, as an operation time of the pump 20.

When oil supplement is finished, the oil supply hose 30 is removed from the oil can 25 and the three-way valve 29 is switched to connect the oil tank 19 with the piping 21. Incidentally, in the event that oil in the oil vat 3 is replaced, after discharging all of oil in the exhaust oil pipe, oil is supplied into the oil vat 3 from the oil can 25 following the above procedures.

In this way, according to the fryer 1 in the above embodiment, the housing portion 23 for the oil can 25 having solid oil is provided at the bottom of the main body case 2 and a part of exhaust gas from the pulse burner 4 is guided into the housing portion 23, so that the oil can 25 is heated by exhaust heat of the exhaust gas. In addition, the oil supply hose 30 is connected between the oil can 25 and an inlet portion of the pump 20 to provide oil in the oil can 25 into the oil vat 3 with the pump 20. Consequently, solid oil for supplement and replacement is stocked in the main body case 2 with a reduced space. Moreover, since the solid oil is heated using exhaust heat, the cost for solid oil liquefaction is reduced. Furthermore, oil in the oil can 25 is provided into the oil vat 3 using the pump 20 of the oil cleaner 5, so that supplement and replacement of oil is performed safely and simply.

In particular, here, since the housing portion 23 includes the heater 28 for heating a bottom surface of the oil can 25, solid oil is liquefied more efficiently and rapidly.

Additionally, since the slide table 24, on which the oil can 25 is mounted, is provided at the bottom of the housing portion 23, the oil can 25 is easily slid into and slid out of the housing portion even if the oil can 25 is heavy.

Furthermore, the fryer 1 includes the temperature detecting means for detecting a temperature of the oil can 25 and the notification means for notifying that the oil can 25 is detected to reach a predetermined temperature by the temperature detecting means. Accordingly, it is immediately recognized that solid oil in the oil can 25 is liquefied and capable of being supplied, so that usability is improved.

In the above embodiment, the lateral walls of the housing portion which houses the oil can have a double structure including hollow portions through which exhaust gas passes. However, not limited to this structure, the exhaust inlet pipe may be arranged inside the housing portion to directly contact with and heat the oil can. Moreover, it is not limited that the heater is provided at the bottom of the housing portion, and it may be widely provided or it may be omitted.

As for a sliding system of the oil can from the housing portion, other than using the slide table, rollers provided at the bottom of the housing portion may be used. Needless to say, the rollers may be omitted.

Furthermore, the three-way valve may be a solenoid valve switched by the controller. In such a case, control of the pump and the three-way valve by the controller enables automatic oil supplement.

Besides, the heating means is not limited to the pulse burner and may be a gas burner. Moreover, except the fryer having a pair of oil vats, the fryer having a single oil vat may be operated in the present invention.

What is claimed is:

1. A fryer comprising a main body case, the main body case including:
an oil vat to be filled with oil;
a heating means for heating the oil in the oil vat by combustion of fuel gas; and
an oil circulation route having an oil tank and an pump for filtering oil discharged from the oil vat and returning the oil into the oil vat,
wherein a housing portion for an oil can having solid oil is provided at the bottom of the main body case, and a part of exhaust gas from the heating means is guided into the housing portion, so that the oil can is heated by exhaust heat of the exhaust gas,
and wherein a hose is connected between the oil can and an inlet portion of the pump to provide oil in the oil can into the oil vat with the pump.

2. The fryer according to claim 1, wherein the housing portion includes a heater for heating at least a bottom surface of the oil can.

3. The fryer according to claim 1, wherein a slide table, on which the oil can is mounted, is provided at the bottom of the housing portion, so that the oil can is easily slid into and out of the housing portion.

4. The fryer according to claim 2, wherein a slide table, on which the oil can is mounted, is provided at the bottom of the housing portion, so that the oil can is easily slid into and out of the housing portion.

5. The fryer according to claim 1, further comprising a temperature detecting means for detecting a temperature of the oil can, and a notification means for notifying that the oil can is detected to reach a predetermined temperature by the temperature detecting means.

6. The fryer according to claim 2, further comprising a temperature detecting means for detecting a temperature of the oil can, and a notification means for notifying that the oil can is detected to reach a predetermined temperature by the temperature detecting means.

7. The fryer according to claim 3, further comprising a temperature detecting means for detecting a temperature of the oil can, and a notification means for notifying that the oil can is detected to reach a predetermined temperature by the temperature detecting means.

8. The fryer according to claim 4, further comprising a temperature detecting means for detecting a temperature of the oil can, and a notification means for notifying that the oil can is detected to reach a predetermined temperature by the temperature detecting means.
